(19) United States
(12) Patent Application Publication
(10) Pub. No.: US 2009/0186150 A1
(43) Pub. Date: Jul. 23, 2009

(54) METHOD FOR MANUFACTURING FERROELECTRIC MEMORY

(75) Inventors: Kenichi KUROKAWA, Suwa (JP); Hiroaki TAMURA, Suwa (JP); Masahisa NAWANO, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/354,861

(22) Filed: Jan. 16, 2009

(30) Foreign Application Priority Data
Jan. 17, 2008 (JP) 2008-007851

(51) Int. Cl. B05D 5/12

(52) U.S. Cl. 427/125; 427/126.3; 427/126.5; 427/123

(57) ABSTRACT

A method for manufacturing a ferroelectric memory includes the steps of: preparing a sol-gel solution; removing solvent from the sol-gel solution to obtain powder; dividing the powder into at least first powder and second powder; obtaining solution with the first powder; coating the solution on a first conductive film; and applying heat treatment to the solution on the first conductive film to form a ferroelectric film.

The entire disclosure of Japanese Patent Application No. 2008-007851, filed Jan. 17, 2008 is expressly incorporated by reference herein.

### BACKGROUND

1. Technical Field

The present invention relates to methods for manufacturing ferroelectric memories.

2. Related Art

Ferroelectric memory devices (FeRAM) are nonvolatile memory devices capable of low voltage and high-speed operation, using spontaneous polarization of the ferroelectric material, and their memory cells can be each formed from one transistor and one capacitor (1T/1C). Accordingly, ferroelectric memory devices can achieve integration at the same level of that of DRAM, and are therefore expected as large-capacity nonvolatile memories.

As the material for forming ferroelectric films that compose ferroelectric capacitors, in other words, as the ferroelectric material, a material composed of compound having a perovskite type crystal structure expressed as an ABO₃ type may preferably be used. Above all, lead zirconate titanate (Pb (Zi, Ti) O₃: PZT) system materials are prevailingly used as the amount of their polarization is large.

As technologies for forming such ferroelectric films, solution methods, such as, a sol-gel method and the like are known (see, for example, Japanese Laid-open Patent Application JP-A-2006-147774). Besides the solution method, for example, sputter method and MOCVD method are also known. Solution methods are advantageous because their material costs are relatively inexpensive compared to those of other methods, and their reproducibility of a film thickness is excellent, such that the solution methods excel in mass-production capability. Moreover, solution methods are advantageous in that other elements can be readily added to PZT type ferroelectric films in order to improve the characteristics of ferroelectric capacitors to be formed. Accordingly, in consideration of mass production in particular based on the aforementioned advantages, the ferroelectric film formation by a solution method is deemed to be advantageous at present.

However, when ferroelectric films are formed by a solution method, the following two problems arise, particularly in connection with the solution containing ferroelectric materials to be used. First, PZT system materials that are prevailing as ferroelectric materials greatly change in their characteristics depending on the composition ratio; and in particular, their optimum range in the Pb composition ratio is very narrow. More specifically, the Pb composition ratio, which is defined by “Pb element/B site element,” has its optimum values around ±2 mol %. When Pb is above this range, leakage current increases. When Pb is below this range, deterioration in the fatigue characteristic of ferroelectric films occurs.

In the film forming method using the aforementioned vapor phase method such as sputter method or the like, the Pb composition ratio may be readily controlled by film forming processing condition. Accordingly, by monitoring the film forming process condition and adjusting the film forming process condition when it goes out of its optimum range, the Pb composition ratio can be readily returned to the optimum range. In contrast, according to the solution method, the Pb composition ratio is decided by the metal composition within the material solution that has been prepared, such that it is very difficult to adjust the composition ratio within the optimum range by film formation by coating, such as, spin coat method to be conducted later. Accordingly, each time the material is prepared, its metal composition ratio may vary, and there are possibilities that the ferroelectric characteristics concerning leakage current and fatigue characteristic of ferroelectric films to be obtained may vary.

Secondly, the material solution, once prepared, finally undergoes chemical reactions in its compositions, such as, polycondensation reaction and the like when heated, and becomes a ferroelectric film as the reaction product (ferroelectric material) obtained is crystallized. However, it is noted that the aforementioned chemical reactions progress slightly even when the material is in the state of solution. When the chemical reactions in the solution state progress above a certain level, a ferroelectric film having desired ferroelectric characteristics may not be obtained even when the film forming process and heating process are conducted by using the material solution. Accordingly, the material solution once prepared has effective time duration, i.e., a serviceable life as a precursor material of the ferroelectric.

However, the serviceable life of PZT type material solution may often be short, for example, for about a week to a month. Therefore, when ferroelectric films in ferroelectric memory devices are to be formed with such material solution, it is important that the material solution is within the serviceable life, in order to provide memory devices to be obtained with favorable ferroelectric characteristics.

### SUMMARY

In accordance with an advantage of some aspects of the invention, there is provided a method for manufacturing a ferroelectric memory device, by which differences in the ferroelectric characteristics of ferroelectric films can be prevented from occurring, and excellent ferroelectric characteristics can be obtained.

A method for manufacturing a ferroelectric memory device in accordance with an embodiment of the invention includes the steps of: preparing a sol-gel solution; removing solvent from the sol-gel solution to obtain powder; dividing the powder into at least first powder and second powder; obtaining solution by using the first powder; coating the solution on a first conductive film; and applying heat treatment to the solution on the first conductive film to form a ferroelectric film.

According to the method for manufacturing a ferroelectric memory device, powder is obtained from a sol-gel solution, a solution is prepared using a part of the powder, thereby forming a ferroelectric film. Accordingly, for example, a sol-gel solution may be prepared in large quantity, and powder obtained from the sol-gel solution may be stored (reserved). Then, by using only a necessary amount of the powder, occurrence of differences in the Pb composition ratio in material solutions to be used can be prevented.

In the method for manufacturing a ferroelectric memory device in accordance with an aspect of the invention, the step of preparing the sol-gel solution may include the steps of: preparing a first sol-gel solution containing Pb and Zr; preparing a second sol-gel solution containing Pb and Ti; and mixing the first sol-gel solution and the second sol-gel solution to obtain the sol-gel solution.

In the method for manufacturing a ferroelectric memory device in accordance with an aspect of the invention, the step of preparing the sol-gel solution may include the steps of: preparing a first sol-gel solution containing Pb and Zr; preparing a second sol-gel solution containing Pb and Ti; preparing a third sol-gel solution containing Pb and Nb; and mixing the first sol-gel solution, the second sol-gel solution and the third sol-gel solution to obtain the sol-gel solution.

Furthermore, in the method for manufacturing a ferroelectric memory device in accordance with an aspect of the invention, the step of obtaining the powder may use a spray dry method.

The method for manufacturing a ferroelectric memory device in accordance with an aspect of the invention may include the step of forming a second conductive film on the ferroelectric film.

Also, in the method for manufacturing a ferroelectric memory device in accordance with an aspect of the invention, the first conductive film may contain at least one of iridium, iridium oxide and platinum, the ferroelectric film may contain PZT or PZTN, and the second conductive film may contain at least one of iridium, iridium oxide and platinum.

Furthermore, a method for manufacturing a ferroelectric memory device in accordance with another embodiment of the invention includes the steps of: preparing a sol-gel solution; removing solvent from the sol-gel solution to obtain powder; dividing the powder into at least first powder and second powder; obtaining a first solution by using the first powder; coating the first solution on a first conductive film formed on a first wafer; applying heat treatment to the first solution on the first conductive film to form a ferroelectric film; obtaining a second solution by using the second powder; coating the second solution on a first conductive film formed on a second wafer; and applying heat treatment to the second solution on the second conductive film to form a second ferroelectric film.

### BRIEF DESCRIPTION OF THE DRAWINGS

FIG. 1 is a flow chart for describing a method for manufacturing a ferroelectric film in accordance with an embodiment of the invention.

FIG. 2 is a schematic cross-sectional view showing the structure of a ferroelectric memory in accordance with an embodiment of the invention.

FIGS. 3A-3C are views for describing steps of the method for manufacturing the ferroelectric memory of FIG. 2.

FIGS. 4A-4C are views for describing steps of the method for manufacturing the ferroelectric memory of FIG. 2.

### DESCRIPTION OF EXEMPLARY EMBODIMENTS

Preferred embodiments of the invention are described below in detail with reference to the accompanying drawings.

Method for Manufacturing Ferroelectric Film

In accordance with an embodiment of the invention, a ferroelectric film composed of compound having perovskite type crystal structure expressed by ABO₃ type is manufactured. As a concrete example, the embodiment is described as to the case where the ferroelectric film is composed of compound having perovskite type crystal structure expressed by Pb (Zr, Ti, Nb) O₃ (hereafter referred to as PZTN).

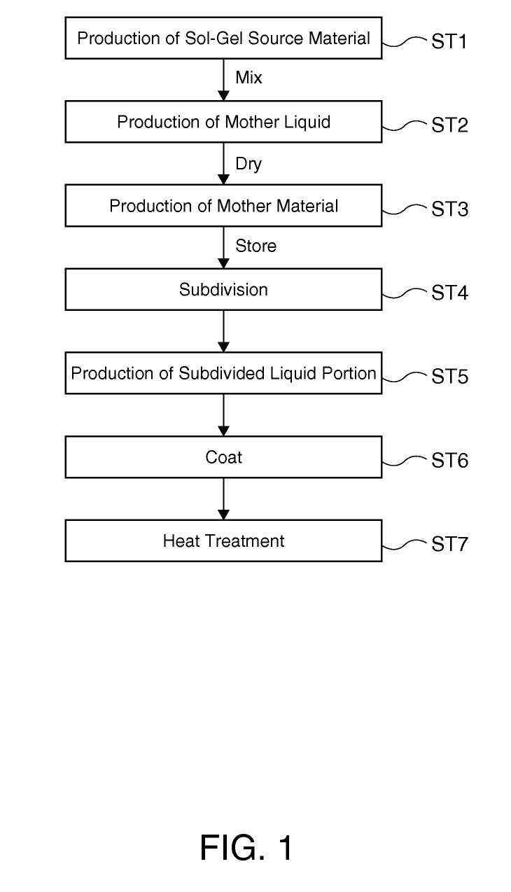

A method for manufacturing a ferroelectric film composed of PZTN is described with reference to a flowchart in FIG. 1. First, a first sol-gel source material solution containing Pb as A site metal and Zr as B site metal in the compound is prepared. Similarly, a second sol-gel source material solution containing Pb as A site metal and Ti as B site metal in the compound is prepared, and a third sol-gel source material solution containing Pb as A site metal and Nb as B site metal in the compound is prepared (step 1, also referred to as ST1; and succeeding steps are referred in a similar fashion).

The first sol-gel source material solution may be prepared by, for example, dissolving polycondensates for forming PbZrO₃ perovskite crystal with Pb and Zr in n-butanol solution in an anhydrous state. Similarly, the second sol-gel source material solution may be prepared by, for example, dissolving polycondensates for forming PbTiO₃ perovskite crystal with Pb and Ti in n-butanol solution in an anhydrous state. Also, the third sol-gel source material solution may be prepared by, for example, dissolving polycondensates for forming PbNbO₃ perovskite crystal with Pb and Nb in n-butanol solution in an anhydrous state. As the polycondensates in the sol-gel source materials, known materials, such as, for example, hydrolysis-condensation products of metal alkoxides may be used.

After preparing the first, second and third sol-gel source material solutions in this manner, the sol-gel source material solutions are mixed such that Pb, Zr, Ti and Nb are contained in a desired composition ratio, thereby forming a mother liquid (ST2). When producing the mother liquid, a variety of additive materials and/or a PbSiO₃ sol-gel solution as a fourth sol-gel source material solution may be added, if necessary, besides the first, second and third sol-gel source material solutions. More specifically, polycarboxylic acid ester, such as, dimethyl succinate is added to the first, second and third sol-gel source material solutions, and n-butanol is added as an organic solvent thereto, to form the mother liquid. For example, the mother liquid composed of the solutions mixed may be produced through mixing the sol-gel source material solutions and dimethyl succinate in a ratio of 1:1, and dissolving the mixed solution in n-butanol such that the sol-gel source material solutions contain a portion of solid by about 10 weight %.

It is noted that, in accordance with the embodiment of the invention, the mother liquid to be produced in this manner may be formed in large quantity in order to cope with mass production. More specifically, the mother liquid may be produced at once in an amount that may be used for an extended period of time, for about one month to six months, in a mass production process. By producing the mother liquid in such a large quantity, influences of errors in measurement of the source materials which may impact on the characteristics of ferroelectric films can be made sufficiently small. When material solution (mother liquid) for forming ferroelectric films is produced in a small amount, the Pb composition ratio in metals composing PZTN, for example, might deviate out of its optimum range due to errors in measurement of the source materials and the like. As a consequence, the characteristics of ferroelectric films to be obtained may be considerably damaged. Moreover, each time material solution for forming ferroelectric films is produced, the characteristics of ferroelectric films obtained may change.

In contrast, in accordance with the invention, the mother liquid (material solution) is formed in large quantity, such that errors in measurement of the source materials become sufficiently small for the entire amount to be measured, compared to the case where the mother liquid is formed in small quantity. Accordingly, influences on the Pb composition ratio due to measurement errors are almost entirely eliminated, and influences that may cause differences in the characteristics of ferroelectric films to be obtained are also entirely eliminated. In the present embodiment, about 100 litter of the mother liquid may be produced.

Next, liquid portion is removed from the produced mother liquid, to obtain solid portion which is used as mother material (ST3). In other words, drying treatment is applied to the mother liquid to remove the liquid portion, thereby obtaining the solid portion. In this instance, a spray dry method may preferably be used as the drying method. More concretely, the mother liquid is sprayed while being heated at predetermined temperatures by a spray dryer (i.e., a spraying/drying apparatus). In this embodiment, because n-butanol is mixed as organic solvent in the mother liquid, the mother liquid is heated around the boiling point of n-butanol (about 120° C.) and sprayed. As a result, the organic solvent is evaporated and removed from the mother liquid during the spraying process, whereby the solid portion is separated and discharged from the spray dryer. At this moment, the solid portion becomes spherical particles (powder) as being influenced by the surface tension. The spherical particles thus formed are used as the mother material in accordance with the embodiment of the invention.

A major portion or the entire portion of the mother material thus formed is stored (reserved) for an extended period of time in the present invention. Any storage method may be used without any particular limitation. However, to prevent moisture absorption, the mother material may preferably be stored in vacuum, in a sealed dry atmosphere, or in a nitrogen atmosphere (i.e., an inert gas atmosphere). In this manner, by storing only the solid portion of the mother material from which its liquid portion is removed, the progress of chemical reaction, such as, polycondensation of the solid portion in each of the sol-gel source material solutions contained in the mother material can be substantially stopped. Therefore, even when the mother material is stored (reserved) for a long time, its serviceable life as the precursor material of forming ferroelectric can be maintained. It is noted that a portion of the mother material formed may be used immediately in a small portion if necessary without being stored, as described below.

Then, when the mother material that has been stored for a predetermined period of time is directly used for manufacturing ferroelectric films, a necessary amount of the mother material for the manufacturer is separated from the stored mother material into a subdivided portion of the material (first powder) (ST4). It is noted that the remaining portion of the mother material after the subdivided portion has been separated may be used as second powder. The subdivided portion can be simply measured and separated from the mother material. In this instance, the particles (powder) composing the mother material include PZTN with their metal ratio being adjusted to a desired ratio, such that an error in measurement that may occur in separating the subdivided portion would not influence the characteristics of ferroelectric films to be obtained.

Next, organic solvent is added and mixed with the obtained subdivided portion to dissolve or disperse the subdivided portion in the organic solvent, thereby producing a subdivided solution portion (solution) (ST5). As the organic solvent, the aforementioned n-butanol may preferably be used. In the present embodiment, n-butanol is used. The amount of n-butanol (organic solvent) to be added may be decided in consideration of the concentration of solids in a subdivided solution portion to be formed, and the viscosity of the subdivided solution portion to be obtained. In particular, the viscosity may be decided based on a coating method to be used (to be described below) as to how the subdivided solution portion should be coated.

The subdivided solution portion thus produced is coated (ST6) on a conductive film (first conductive film) that is prepared by a separate process, and the coated subdivided solution portion is heat-treated to form a ferroelectric film (ST7). As the coating method, a spin coat method may be commonly used, but a variety of other wet coating methods, such as, a roll coater method and a droplet ejection method including an ink jet method may be used. Also, in the heat treatment, the coated solution may be dried and degreased at temperatures, for example, between about 120° C. and about 400° C. as pre-treatment, and then heated at temperatures between 450° C. and 650° C. in an oxygen containing atmosphere, thereby obtaining a ferroelectric film. The heating (heat treatment) at temperatures between 450° C. and 650° C. in an oxygen containing atmosphere may preferably be conducted by Rapid Thermal Annealing (RTA) treatment with a lamp device for about one minute to about five minutes, whereby the obtained ferroelectric film can be favorably crystallized in (111) crystal orientation by the Rapid Thermal Annealing treatment.

The mother material produced is used until entirely consumed in portions each being used for each process of manufacturing ferroelectric films (i.e., for each manufacturing batch) through repeating the steps ST4 to ST7 shown in FIG. 1. Therefore, according to the method for manufacturing ferroelectric films described above, no difference occurs in the metal composition ratio (for example, Pb composition ratio) among divided material solutions to be used (i.e., subdivided solution portions). Moreover, because each portion of material solution (each subdivided solution portion) is formed such that the Pb composition ratio is in the optimum range, differences in the characteristics of ferroelectric films that may originate from differences in material solutions can be prevented, and ferroelectric films can be formed with excellent ferroelectric characteristics such as leakage current and fatigue characteristics. Moreover, even when a large quantity of mother material is produced, and stored (reserved) for an extended period of time, its serviceable life as the precursor material for forming ferroelectric can be maintained, and therefore ferroelectric films can always be formed with excellent ferroelectric characteristics. Moreover, the ferroelectric films thus obtained have no difference among manufacturing processes (manufacturing batches), and have sufficiently favorable ferroelectric characteristics.

It is noted that, in the embodiment described above, Pb (Zr, Ti, Nb)O₃ (PZTN) is used as a compound having perovskite type crystal structure, which is expressed by ABO₃, and therefore ferroelectric films are manufactured with PZTN. However, the invention is not limited to this embodiment, and Pb(Zr, Ti)O₃ (PZT) may be used as the compound. In this case, as sol-gel source material solutions that are used as starting materials of mother liquid, the first sol-gel source material solution and the second sol-gel source material solution alone may be used.

(Ferroelectric Memory)

Next, a method for manufacturing a ferroelectric film (hereafter referred to as a ferroelectric memory device) including the ferroelectric film manufacturing method described above is described.

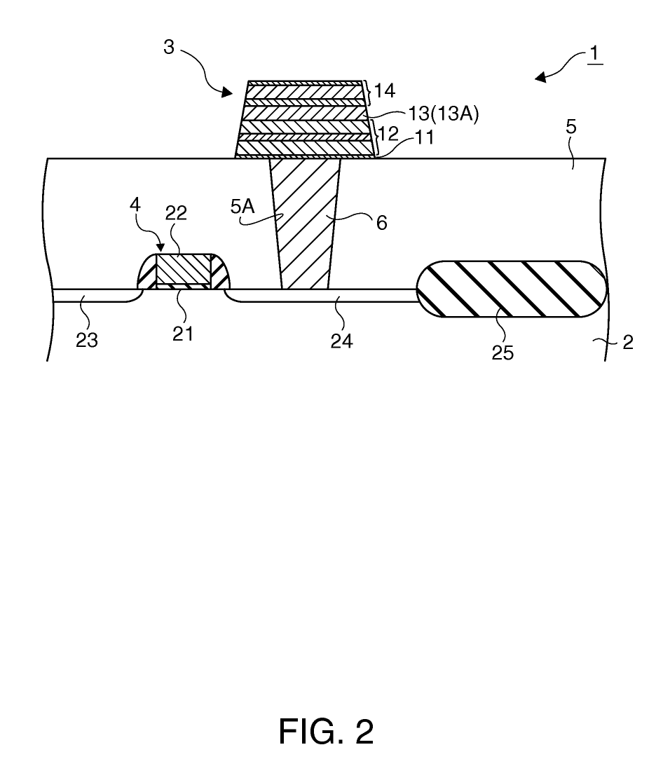

FIG. 2 is a schematic cross-sectional view in enlargement of an example of a ferroelectric memory device that can be obtained by the ferroelectric memory manufacturing method in accordance with an embodiment of the invention. In FIG. 2, a reference numeral 1 denotes a ferroelectric memory device, and a reference numeral 3 denotes a ferroelectric capacitor. The ferroelectric memory device 1 has a stacked structure equipped with a ferroelectric capacitor. As shown in FIG. 2, the ferroelectric memory device 1 is equipped with a semiconductor substrate 2, the ferroelectric capacitor 3 formed on the semiconductor substrate 2, and a switching transistor (hereafter referred to as a transistor) 4 that functions as a driving element for the ferroelectric capacitor 3.

The semiconductor substrate 2 is composed of single crystal silicon (Si), and has on its top surface side an interlayer dielectric film 5 composed of silicon oxide (SiOx) or the like. Further, a contact hole 5A that penetrates the interlayer dielectric film 5 is formed in a region corresponding to a second impurity region layer 24 to be described below among the interlayer dielectric film 5, and a plug 6 is embedded in the contact hole SA. The plug 6 is formed from a conductive material filled in the contact hole 5A, and may be composed of, for example, tungsten (W), molybdenum (Mo), tantalum (Ta), titanium (Ti), nickel (Ni) or the like. Above all, tungsten (W) is most preferable, and therefore tungsten is used in the present embodiment.

The ferroelectric capacitor 3 is equipped with a barrier layer 11 formed on the interlayer dielectric film 5 and the plug 6, a lower electrode 12 laminated on the barrier layer 11, a ferroelectric film 13 laminated on the lower electrode 12, and an upper electrode 14 laminated on the ferroelectric film 13. The barrier layer 11 that is conductive and conductively connected to the plug 6, and is composed of a material that includes crystalline and oxygen barrier property. The barrier layer 11 may be formed from, for example, TiAlN, TiAl, TiSiN, TiN, TaN, TaSiN or the like. In accordance with the present embodiment, the barrier layer 11 is formed from TiAlN with its crystalline having (111) crystal orientation.

The lower electrode 12 is composed of, for example, at least one of iridium (Ir), platinum (Pt), ruthenium (Ru), rhodium (Rh), palladium (Pd), osmium (Os), or an alloy or an oxide of any of the foregoing materials. The lower electrode 12 may preferably be composed of Ir or Pt. Ir and Pt have strong (111) self-orienting property, and are favorably oriented to (111) crystal orientation, when formed on the barrier layer 11 having the (111) crystal orientation.

When the lower electrode 12 is crystalline, crystal orientations of the lower electrode 12 and the barrier layer 11 may preferably be in epitaxial orientation relation at their interface where they contact each other. In this case, the crystal orientation of the lower electrode 12 and the crystal orientation of the ferroelectric film 13 may also preferably be in epitaxial orientation relation at their interface where they contact each other.

For example, when the barrier layer 11 belongs to a cubic system and has the (111) crystal orientation, or belongs to a hexagonal system and has the (001) crystal orientation, the lower electrode 12 may preferably have the (111) crystal orientation. In this configuration, it becomes easier to make the ferroelectric layer 13 to have a tetragonal crystal structure with its crystal orientation being in the (111) crystal orientation when the ferroelectric film 13 is formed on the lower electrode 12.

The lower electrode 12 may be formed from a single layer film other than an Ir or Pt layer or a multilayer film of laminated layers, as long as the film is favorably oriented to the (111) crystal orientation, reflecting the (111) crystal orientation of the barrier layer 11. The multilayer film may preferably be formed from layers of Ir, IrOx and Pt laminated in this order from the side of the barrier layer 11, and such a multilayer film (i.e., a film of laminated layers) is used as the lower electrode 12 in accordance with the present embodiment.

The ferroelectric film 13 is formed from the ferroelectric film in accordance with the embodiment of the invention described above, and is composed of a compound having perovskite type crystal structure expressed by Pb(Zr, Ti, Nb)O₃ (PZTN). In this PZTN, Nb has generally the same size as that of Ti (ionic radii are close to each other and atomic radii are identical), and weighs two times, such that it is hard for atoms to slip out the lattice even by collision among atoms by lattice vibration. Further, its valence is +5, which is stable. Therefore, even if Pb slips out, the valence resulting from the vacated Pb can be supplemented by Nb⁵⁺. Also, even if a Pb vacancy occurs at the time of crystallization, it is easier for Nb having a smaller size to enter than O having a larger size to slip out. Furthermore, Nb may also have a valence of +4, such that it can sufficiently substitute for Ti⁴⁺. Moreover, Nb has in effect a very strong covalent bond, and it is believed that Pb is also difficult to slip out.

Accordingly, when forming the ferroelectric film by heat treatment, Pb may readily slip out from the crystal of PZT, but such Pb slip out is suppressed when Nb is added. It is noted that the ferroelectric film 13 is formed by a solution method, as described above.

The upper electrode 14 may be made of the same material as that of the lower electrode 12 described above, or made of aluminum (Al), silver (Ag), nickel (Ni), or the like. The upper electrode 14 may be either a single layer film or a multilayer film of laminated layers. In particular, the upper electrode 14 may preferably be formed from a multilayer film of Pt, IrOx, Ir layers.

The transistor 4 is equipped with a gate dielectric layer 21 formed in a portion of the surface of the semiconductor substrate 2, a gate conductive layer 22 formed on the gate dielectric layer 21, first and second impurity region layers 23 and 24 which are source and drain regions, respectively, formed in the surface layer of the semiconductor substrate 2. The transistor 4 is conductively connected to the lower electrode 12 of the ferroelectric capacitor 3 through the plug 6 formed on the second impurity region layer 24 and the barrier layer 11. Also, a plurality of transistors 4 may be formed at intervals on the semiconductor substrate 2, and element isolation regions 25 are formed between adjacent ones of the transistors 4 to isolate and insulate the transistors 4 from one another.

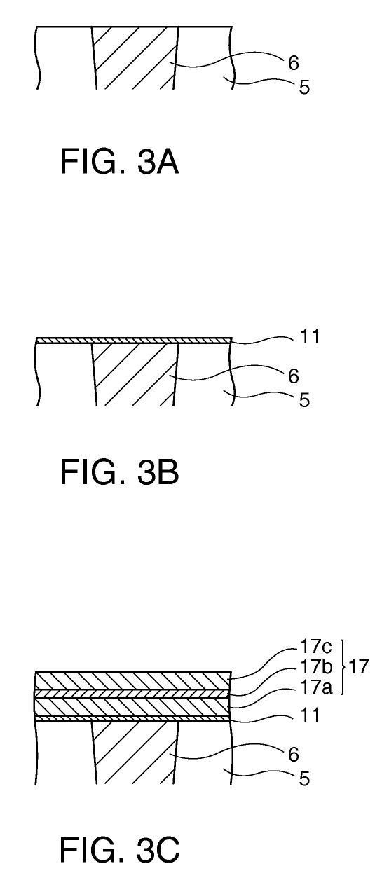

To manufacture the ferroelectric memory device 1 having the structure described above, first and second impurity region layers 23 and 24 are formed in the surface layer of the semiconductor substrate 2, and the transistor 4 and the interlayer dielectric film 5 are formed on the semiconductor substrate 2, in an ordinary manner. Then, as shown in FIG. 3A, contact holes are formed in the interlayer dielectric film 5, and the contact holes are filled with, for example, tungsten (W) as conductive material, thereby forming plugs 6.

Next, as shown in FIG. 3B, a barrier layer 11 composed of TiAlN is formed on the interlayer dielectric film 5 and the plug 6 by, for example, a sputter method. As the barrier layer 11 is formed from TiAlN having crystalline as described above, the barrier layer 11 can be oriented to the (111) crystal orientation.

Then, as shown in FIG. 3C, a lower electrode film (first conductive film) 17 is formed on the barrier layer 11. In accordance with the present embodiment, the lower electrode film 17 is formed through laminating films of iridium (Ir), IrOₓ, such as, IrO₂ and Pt in this order by a sputter method, thereby sequentially laminating an Ir layer 17a, an IrOx layer 17b and a Pt layer 17c. When the lower electrode film 17 is formed in this manner, the lower electrode film 17 has favorable crystallinity, and the crystal orientation of the barrier layer 11 is reflected in the lower electrode film 17, whereby the lower electrode film 17 has the (111) crystal orientation, which is the same as that of the barrier layer 11.

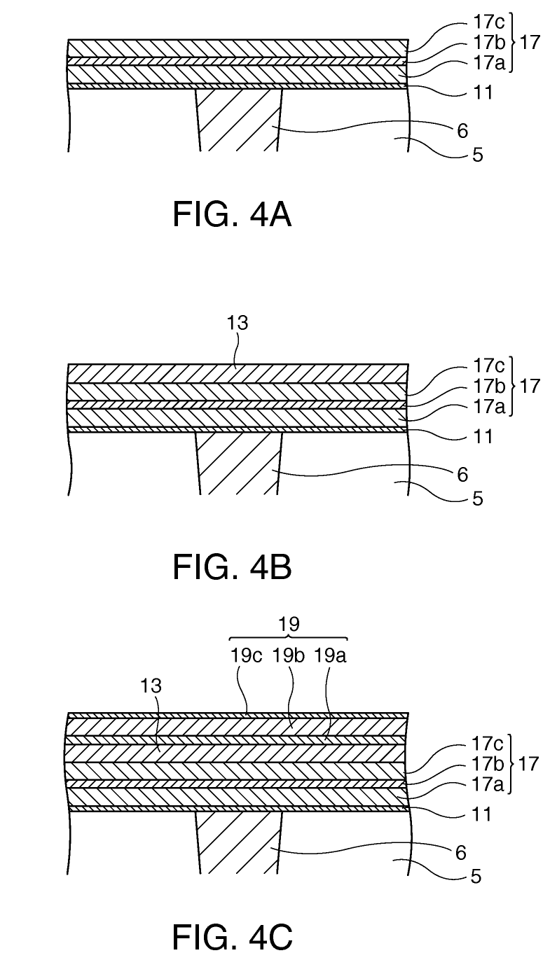

Next, as shown in FIG. 4A, a ferroelectric material layer 18 is formed on the lower electrode film 17 by a solution method. The solution method is conducted in a manner as described above in conjunction with the ferroelectric film manufacturing method, wherein mother material is produced from mother liquid produced in advance in large quantity and stored, a portion thereof is divided from the stored mother material, and solvent is added to the divided portion to form a subdivided solution portion. In other words, the subdivided solution portion is coated on the lower electrode film 17 that is a conductive film by a spin coat method, thereby forming the ferroelectric material layer 18.

Then, the formed ferroelectric material layer (subdivided solution layer) 18 is dried and degreased at temperatures of about 120° C.-400° C. Then, in accordance with the present embodiment, the layer is treated by Rapid Thermal Annealing treatment (RTA treatment) at 650° C. for about one minute using a lamp device, whereby the ferroelectric material is crystallized, thereby forming a ferroelectric film 13 having a thickness of about 120 nm on the lower electrode film 17, as shown in FIG. 4B. By forming the ferroelectric film 13 in this manner, its crystal structure is defined by the metal element ratio in the subdivided solution portion at the time of film formation, and the ferroelectric film 13 is preferentially oriented well in the (111) crystal orientation, reflecting the (111) crystal orientation of the Pt layer 17c on the lower electrode film 17.

Then, as shown in FIG. 4C, an upper electrode film (second conductive film) 19 is formed on the ferroelectric film 13. In the present embodiment, Pt is deposited in a film by a sputter method or the like, thereby forming a Pt layer 19a. Then, recovery annealing is conducted with a lamp device, and then IrOx, such as, IrO₂, and Ir are deposited in films in this order on the Pt layer 19a by a sputter method of the like, thereby laminating an IrOx layer 19b and an Ir layer 19c.

Thereafter, a resist layer (not shown) is formed on the upper electrode film 19, and the resist layer is patterned by exposure and development into a predetermined shape. Then, by using the obtained resist pattern (not shown), the upper electrode film 19, the ferroelectric film 13, the lower electrode film 17 and the barrier layer 11 are successively etched, whereby a ferroelectric capacitor 3 shown in FIG. 1 is obtained. It is noted that the upper electrode film 19 is formed into an upper electrode 14 by the patterning, and the lower electrode film 17 is formed into a lower electrode 12 by the patterning. Upon forming the ferroelectric capacitor 3, an interlayer dielectric film (not shown) that covers the ferroelectric capacitor 3 is further formed, and upper wirings (not shown) or the like are formed over the interlayer dielectric film, whereby a ferroelectric memory device 1 is obtained.

In ferroelectric memory devices 1 obtained in this manner, ferroelectric films 13 are manufactured by the ferroelectric film manufacturing method in accordance with the embodiment of the invention described above, such that the ferroelectric films 13 do not have differences among manufacturing processes (manufacturing batches), and have sufficiently favorable ferroelectric characteristics, such that the ferroelectric memory devices have excellent memory characteristics.

It is noted that many changes can be made within the range that does not depart from the subject matter of the invention, without being limited to the embodiment described above. For example, in the embodiment described above, when the upper electrode film 19, the ferroelectric material layer 18 and the lower electrode film 17 are etched, a resist pattern is used as a mask. However, a hard mask composed of inorganic material may be use together. Moreover, a dielectric hydrogen barrier, such as, alumina (Al₂O₃) or the like, that covers the side surface and the top surface of the ferroelectric capacitor 3 may be provided.

What is claimed is:

1. A method for manufacturing a ferroelectric memory, comprising the steps of:
preparing a sol-gel solution;
removing solvent from the sol-gel solution to obtain powder;
dividing the powder into at least first powder and second powder;
obtaining solution with the first powder;
coating the solution on a first conductive film; and
applying heat treatment to the solution on the first conductive film to form a ferroelectric film.

2. A method for manufacturing a ferroelectric memory according to claim 1, wherein the step of preparing the sol-gel solution includes the steps of:
preparing a first sol-gel solution containing Pb and Zr;
preparing a second sol-gel solution containing Pb and Ti; and
mixing the first sol-gel solution and the second sol-gel solution to obtain the sol-gel solution.

3. A method for manufacturing a ferroelectric memory according to claim 1, wherein the step of preparing the sol-gel solution includes the steps of:
preparing a first sol-gel solution containing Pb and Zr;
preparing a second sol-gel solution containing Pb and Ti;
preparing a third sol-gel solution containing Pb and Nb; and
mixing the first sol-gel solution, the second sol-gel solution and the third sol-gel solution to obtain the sol-gel solution.

4. A method for manufacturing a ferroelectric memory according to claim 1, wherein the step of obtaining the powder uses a spray dry method.

5. A method for manufacturing a ferroelectric memory device according to claim 1, comprising the step of forming a second conductive film on the ferroelectric film.

6. A method for manufacturing a ferroelectric memory according to claim 1, wherein the first conductive film contains at least one of iridium, iridium oxide and platinum, the ferroelectric film contains one of PZT and PZTN, and the second conductive film contains at least one of iridium, iridium oxide and platinum.

7. A method for manufacturing a ferroelectric memory, comprising the steps of:
preparing a sol-gel solution;
removing solvent from the sol-gel solution to obtain powder;
dividing the powder into at least first powder and second powder;
obtaining a first solution by using the first powder;
coating the first solution on a first conductive film formed on a first wafer;
applying heat treatment to the first solution on the first conductive film to form a first ferroelectric film;
obtaining a second solution by using the second powder;
coating the second solution on a first conductive film formed on a second wafer; and
applying heat treatment to the second solution on the second conductive film to form a second ferroelectric film.
